(19) United States
(12) Patent Application Publication
(10) Pub. No.: US 2019/0024444 A1
(43) Pub. Date: Jan. 24, 2019

(54) A BOWED PANEL

(71) Applicant: THE WEST RETAIL GROUP LIMITED, Hotham, York East Yorkshire (GB)

(72) Inventor: Malcolm HEALEY, Hotham, York East Yorkshire (GB)

(21) Appl. No.: 16/065,353

(22) PCT Filed: Dec. 22, 2015
(86) PCT No.: PCT/GB2015/054130

§ 371 Date: Jun. 22, 2018

(51) Int. Cl. E06B 3/70; E06B 5/00; A47B 96/20; B27D 1/08; B27M 3/18

(52) U.S. Cl. CPC E06B 3/7007; E06B 5/006; B27M 3/18; B27D 1/08; A47B 96/205

(57) ABSTRACT

The invention relates to a bowed panel (102) comprising a frame (104, 106, 108, 110) and at least one sheet (112, 114), wherein the frame comprises at least one arcuate frame member (104, 106) and the frame is arranged to define an arcuate surface and wherein the at least one sheet is secured to the frame. The invention extends to a bowed cabinet door, drawer front or cabinet panel and a method of making a bowed panel.

The present invention relates to a bowed panel and method of making the same. In particular to a bowed panel for use in cabinetry, such as a bowed panel or door for a cabinet, for example a bowed kitchen cabinet panel or door.

Cabinet manufacture, particularly for kitchens and the like has, in recent years, become largely a mass production industry. For mainly aesthetic reasons and in line with the tastes of the consumer, it has become popular for some kitchen cabinetry to have bowed panels, doors and drawer fronts.

Such curved panels known in the art are manufactured by arranging multiple sheets of thin material and then in gluing them together to form a laminate and bending the formed panel, for example over a mould, to form the bowed panel. This is a very expensive, time consuming process and can produce a product where the curve is not consistent. Furthermore, the thin material may have a tendency to return to its natural state, which is substantially planar, also leading to inconsistency. The door may also be very heavy using this method of construction. This means that for tall doors, for example larder doors, excess stress is placed on the hinges and this may impact on the durability of cabinet.

It is an object of aspects of the present invention to address the above mentioned or other problems.

According to a first aspect of the present invention there is provided a bowed panel comprising a frame and at least one sheet, wherein the frame comprises at least one arcuate frame member and the frame is arranged to define an arcuate surface and wherein the at least one sheet is secured to the frame.

Preferably, the bowed panel is a cabinet door, drawer front or cabinet panel. For example, a cabinet door, drawer front or cabinet panel that is convex or concave. In one preferred embodiment, the bowed panel is a kitchen cabinet door or panel or drawer front.

Preferably, the frame comprises at least one side member and preferably at least one end member.

Preferably, the frame comprises a first side member and a second side member. The first and second side members are preferably arranged at opposite sides of the bowed panel. In one embodiment, the first and second side members are each substantially planar. Preferably, the first and second side members are arranged in a manner that is offset from parallel to each other. In one embodiment, the first and second side members are arranged in a manner such that they are in a spatially separated herringbone pattern.

Preferably, the frame comprises a first end member and a second end member. The first and second end members are preferably arranged at opposite ends of the bowed panel, for example at an upper and lower end, respectively. In one embodiment, the first and second end members are each arcuate. Preferably, the first and second end members are arranged in a manner that is generally parallel to each other.

In one embodiment, the frame may comprise a plurality of arcuate end members. For example, the frame may comprise two, three, four or five arcuate end members arranged generally parallel to one another. For example, the frame may comprise a plurality of arcuate end members stacked on top of each other to form a solid arcuate frame. In one embodiment, the frame may comprise two arcuate end members arranged generally parallel to one another. In one embodiment, the frame may comprise three arcuate end members arranged generally parallel to one another.

It will be appreciated by a person skilled in the art that the plurality of arcuate end members may add structural rigidity to the bowed panel. It will also be appreciated by a person skilled in the art that the number of arcuate end members may be chosen so as to add sufficient rigidity for the size of the door. For example, a tall larder door may require more arcuate end members than a smaller door, for example, for a kitchen cabinet.

Preferably, the first side member and second side member and the first end member and second end member are joined together to form the frame. The frame, in plan, is preferably substantially a parallelogram. For the avoidance of doubt, reference here to “in plan” refers to a view from above, wherein the arcuate surface is seen as flattened.

Preferably, the or each arcuate frame member is formed from a bulk material. Preferably, the arcuate characteristics of the frame are not imparted thereto by a bending process. Preferably, the arcuate characteristics of the frame are imparted by cutting the materials into an arcuate shape. In one embodiment, the frame is preferably machined from a bulk material, such as cut from a bulk material.

The frame may be formed form any suitable material. In one embodiment the frame is formed from wood or a wood substitute material, such as a reconstituted material, for example medium density fibreboard (MDF). In one embodiment, the or each side member may be formed from a different material to the or each end member.

In one preferred embodiment, the frame is formed from a first side member and a second side member, a first arcuate end member and a second arcuate end member, each of which being formed from wood or a wood substitute material, such as a reconstituted material, for example medium density fibreboard (MDF), wherein the arcuate characteristics of the first arcuate end member and the second arcuate end member are imparted by cutting the materials into an arcuate shape.

Preferably the at least one sheet is substantially pliable, suitably to thereby allow it to be bent to be secured to the frame.

The at least one sheet may be formed from, for example wood or a wood substitute material, such as a reconstituted material, for example high density fibreboard, such as 2 mm high density fibreboard, medium density fibreboard (MDF) or a combination thereof. Suitably the at least one sheet may be formed from high density fibreboard, such as 2 mm high density fibreboard. The at least one sheet may be formed from an opaque or transparent material.

In one embodiment, the at least one sheet may comprise a plurality of sheets. In one embodiment, the at least one sheet may comprise an outer sheet and an inner sheet. Suitably the outer sheet is secured to one face of the bowed panel and the inner sheet is secured to an opposite face of the bowed panel. The outer sheet may be secured to a first face of the frame and the inner sheet may be secured an opposite face of the frame.

Where the bowed panel comprises an outer sheet and an inner sheet secured to outer and inner faces thereof, a void therebetween may be formed. A core material may optionally be present in the void. The core material, when present, may comprise an insulating material. The core material, when present, may add structural rigidity to the bowed panel. The core material, when present, may comprise a sheet of material, which may be a pliable material. The core material, when present, may be present in a portion of the void or may substantially fill the void. Suitably the core material, when present, may substantially fill the void.

The core material may comprise, for example, a polystyrene material.

It will be appreciated by a person skilled in the art that, where the bowed panel comprises an outer sheet and an inner sheet secured to outer and inner faces thereof, the void formed therebetween may remain unfilled (i.e. a core material may not be present).

The bowed panel may further comprise edging means, such as one or more edging strip around the perimeter of thereof. The edging means may be purely decorative, or may be operable to offer some rigidity to the frame, or both.

According to a further aspect of the present invention there is provided a bowed cabinet door, drawer front or cabinet panel comprising a frame and at least one sheet, wherein the frame comprises at least one arcuate frame member and the frame is arranged to define an arcuate surface and wherein the at least one sheet is secured to the frame.

According to a further aspect of the present invention there is provided a method of making a bowed panel, the method comprising arranging a frame having at least one arcuate frame member to define an arcuate surface, and securing at least one sheet to the frame.

All of the features contained herein may be combined with any of the above aspects and in any combination.

For a better understanding of the invention, and to show how embodiments of the same may be carried into effect, reference will now be made, by way of example, to the accompanying diagrammatic drawings in which:

FIG. 1 shows an exploded view of a bowed panel;

FIG. 2 shows an end view of the bowed panel;

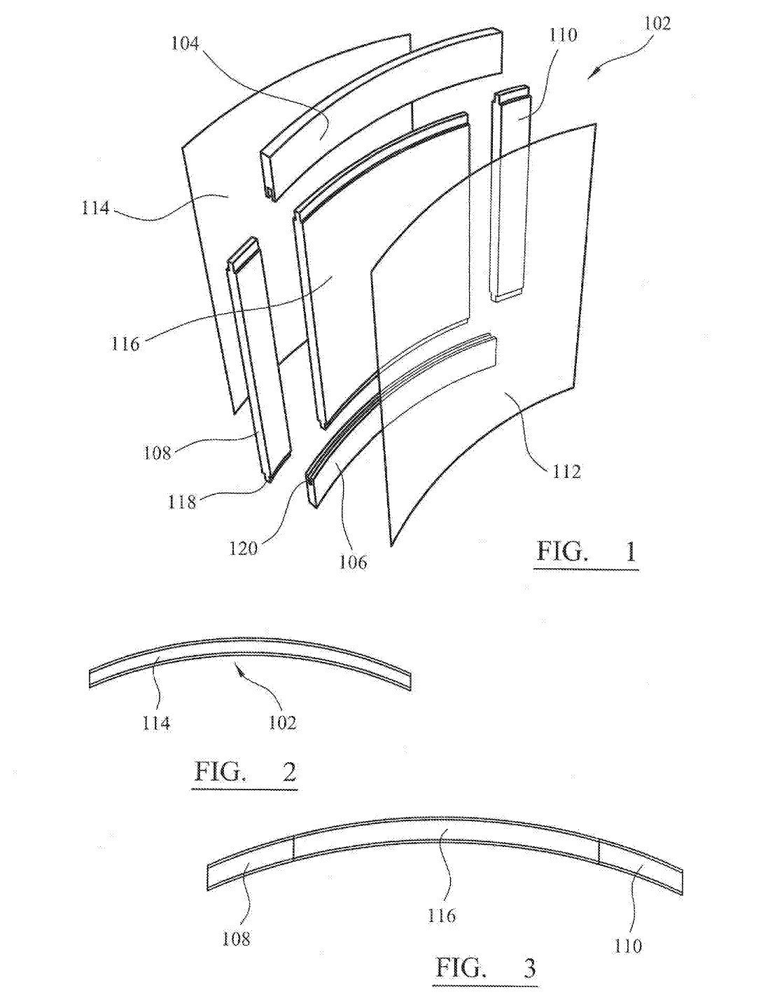

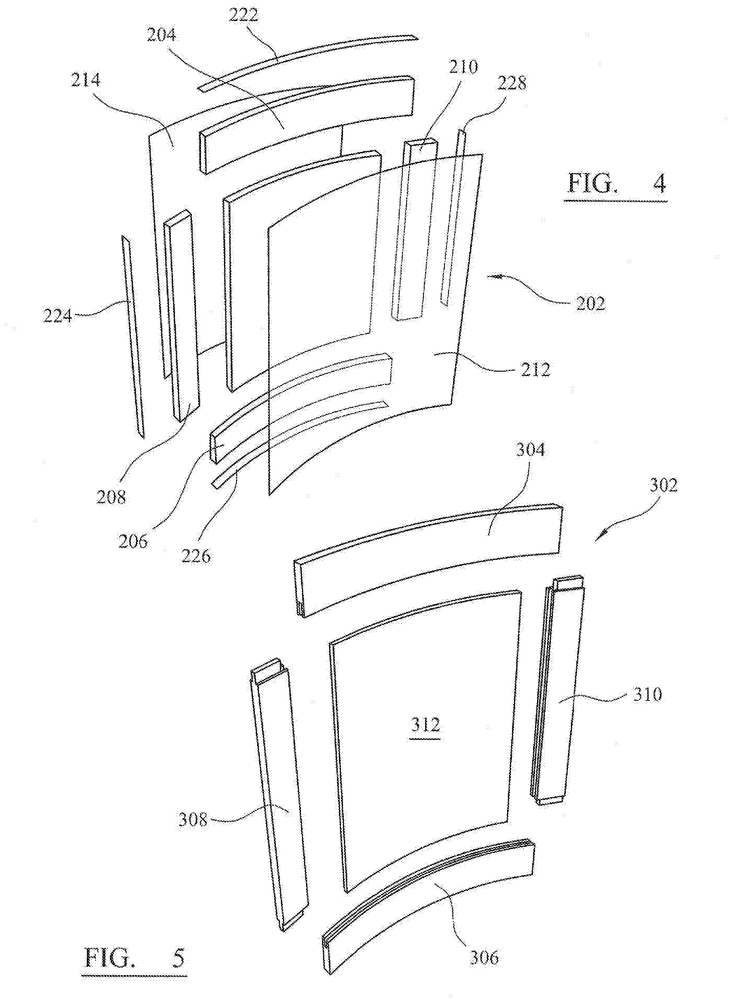

FIG. 3 shows a cross sectional view through the bowed panel of FIG. 1;

FIG. 4 shows an exploded view of a second embodiment of a bowed panel;

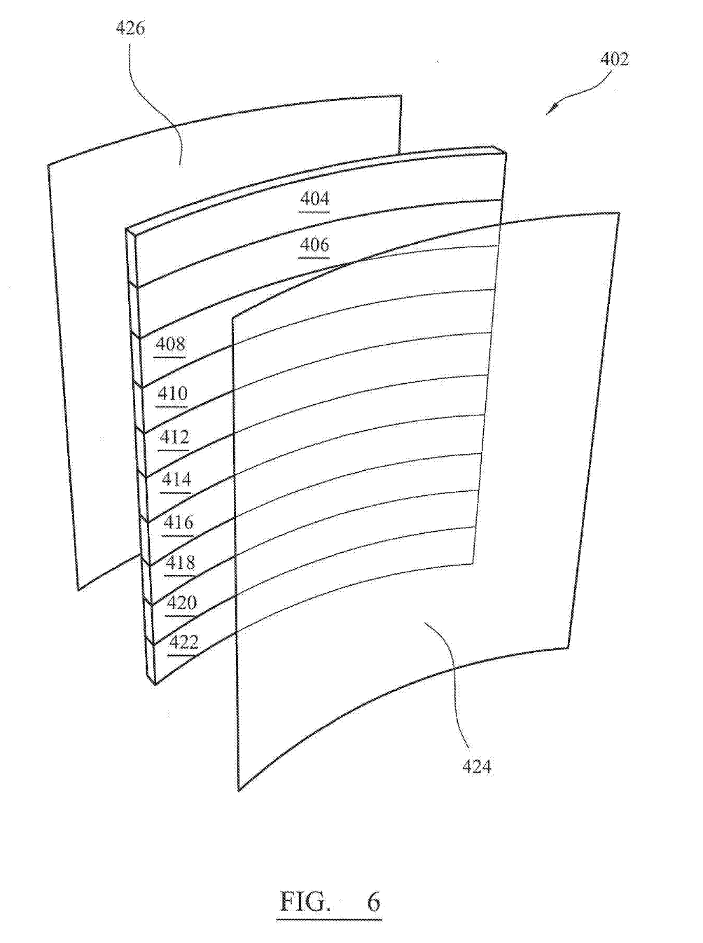

FIG. 5 shows an exploded view of a third embodiment of a bowed panel; and

FIG. 6 shows a partially exploded view of a fourth embodiment of a bowed panel.

Referring to FIG. 1 there is shown an exploded view of a bowed panel 102 having a frame formed from an upper end member 104, a lower end member 106, a first side member 108 and a second side member 110. The upper end member 104 and the lower end member 106 are arcuate. This is described in more detail with regard to FIG. 2, below. The bowed panel also comprises an outer sheet 114 and an inner sheet 112, which are situated one either face of the bowed panel. Between the sheets 112, 114 is a sheet of a core material 116, which in the present embodiment is a bendable sheet of compressed polystyrene.

FIG. 1 is an exploded view, but it will be understood that, in an unexploded form, the four frame members 104, 106, 108, 110 are joined to form a perimeter of the bowed panel, which is generally rectangular. In the present embodiment, the frame members 104, 106, 108, 110 are joined using a tongue and groove (tenon) system as depicted by tongue and groove 118, 120. In this embodiment, the core material 116 also has a tongue around the edge thereof to fit into the groove on the frame members for ease of construction. The sheets 112, 114 are bent over the frame members 104, 106, 108, 110 and secured thereto using glue and pins (not shown) to form skins on the outer faces of the bowed panel 102 and to encase the core material 116.

Referring now to FIG. 2 there is shown a view of the bowed panel 102 from above. The arcuate nature of the end frame member 114, which causes the panel to be bowed. The end frame member 114 is formed by cutting from a piece of MDF into the desired shape and in this manner, no bending of the frame is required to arrive at the arcuate shape.

Referring to FIG. 3 there is shown a cross sectional view through the bowed panel 102. The side frame members 108, 110 are shown at either side, with an arcuate sheet of core material 116 therebetween. The inner sheet 112 and the outer sheet 114 are also shown on the outer faces of the bowed panel. The inner sheet is formed from a polystyrene material that is pliable and therefore able to be bent into an arcuate shape to match that of the frame. However, this material would not be suitable on its own to form the structure of the panel 102.

Referring now to FIG. 4 there is shown a second embodiment of the bowed panel 202. This embodiment is substantially the same as the first embodiment 102, and like parts have been given like numerals (except with the starting number “2”, rather than “1”). The four frame members 204, 206, 208, 210, of the bowed panel of this embodiment are joined using dowels and sockets (not shown). The second embodiment also has edging strips 222, 224, 226, 228 around the bowed panel 202 for decorative reasons. The material and surface decoration of the edging strips 222, 224, 226, 228 can be changed depending on the intended end use of the bowed panel.

Referring now to FIG. 5 there is shown a third embodiment of a bowed panel 302. This embodiment is of a simpler construction and comprises two end frame members 304, 306 and two side frame members 308, 310, which are similarly shaped to those of the first and second embodiment, described above. However, this embodiment comprises a single sheet 312 that is arranged to be bent and housed within the frame to thereby form a bowed panel 302. In this manner, the frame members 304, 306, 308, 310 provide structural integrity to the bowed panel 302, while the sheet 312 is pliable to form the arcuate surface of the bowed panel 302.

Referring now to FIG. 6 there is shown a fourth embodiment of the bowed panel 402, which comprises ten frame members (404, 406, 408, 410, 412, 414, 416, 418, 420, 422) secured together to form a solid arcuate frame and having an outer sheet 424 and an inner sheet 426. Each of the ten frame members (404, 406, 408, 410, 412, 414, 416, 418, 420, 422) are arcuate equivalent and each correspond to the upper end member and lower end member of the first to third embodiments, discussed above.

The frame members described above are machined from a material, such as MDF, rather than being bent into the arcuate shape. This has the advantage that the curve can be closely controlled to be of any shape without irregularities. Also, because the frame members are not formed from glued laminar sheets, the requirement for bending is removed and the risk of delamination also removed.

The above embodiments refer specifically to bowed panels, but it will be appreciated by a person skilled in the art, that such a panel can easily be a cabinet door by use of the appropriate hinges and handles. Similarly, such a panel construction can also easily be used as a drawer front, by making the panel of the appropriate size and with the appropriate handle arrangement.

Although preferred embodiment(s) of the present invention have been shown and described, it will be appreciated by those skilled in the art that changes may be made without departing from the scope of the invention as defined in the claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A bowed panel comprising a frame and at least one sheet, wherein the frame comprises at least one arcuate frame member and the frame is arranged to define an arcuate surface and wherein the at least one sheet is secured to the frame.

2. The bowed panel according to claim 1, wherein the frame comprises at least one side member and at least one end member.

3. The bowed panel according to claim 2, wherein the frame comprises a first side member and a second side member.

4. The bowed panel according to claim 3, wherein the first and second side members are arranged at opposite sides of the bowed panel.

5. The bowed panel according to claim 2, wherein the frame comprises a first end member and a second end member.

6. The bowed panel according to claim 5, wherein the first and second end members are arranged at opposite ends of the bowed panel.

7. The bowed panel according to claim 2, wherein the frame comprises a plurality of arcuate end members.

8. The bowed panel according to claim 1, wherein arcuate characteristics of the frame are imparted by cutting materials into an arcuate shape.

9. The bowed panel according to claim 1, wherein the at least one sheet is substantially pliable.

10. The bowed panel according to claim 1, wherein the at least one sheet comprises an outer sheet and an inner sheet.

11. The bowed panel according to claim 10, wherein the outer sheet is secured to one face of the bowed panel and the inner sheet is secured to an opposite face of the bowed panel.

12. The bowed panel according to claim 11, wherein a void is formed between the outer sheet secured to one face of the bowed panel and the inner sheet secured to an opposite face of the bowed panel.

13. The bowed panel according to claim 12, further comprising a core material in the void.

14. A bowed cabinet door, drawer front or cabinet panel comprising a frame and at least one sheet, wherein the frame comprises at least one arcuate frame member and the frame is arranged to define an arcuate surface and wherein the at least one sheet is secured to the frame.

15. A method of making a bowed panel, the method comprising arranging a frame having at least one arcuate frame member to define an arcuate surface, and securing at least one sheet to the frame.
